(19) United States
(12) Patent Application Publication
(10) Pub. No.: US 2025/0344240 A1
(43) Pub. Date: Nov. 6, 2025

(54) METHOD FOR OPERATING A RADIO NODE, AND RADIO NODE

(71) Applicant: Diehl Metering Systems GmbH, Nürnberg (DE)

(72) Inventors: Matthias Klatt, Nürnberg (DE); Johannes Wechsler, Spalt (DE); Christian Bär, Schwabach (DE); Dominik Elberskirch, Nürnberg (DE)

(21) Appl. No.: 19/066,542

(22) Filed: Feb. 28, 2025

(30) Foreign Application Priority Data
May 5, 2024 (DE) 10 2024 106 303.3

(51) Int. Cl. H04W 72/563; H04W 4/38; H04W 72/566

(52) U.S. Cl. CPC H04W 72/563; H04W 72/566; H04W 4/38

(57) ABSTRACT

A method operates a bidirectional radio node, in particular a sensor node, preferably a consumption meter, in a network infrastructure. The radio node supports at least one radio technology and is preferably operated with an autonomous energy source, in particular in the form of a long-life battery. The radio node dispatches data in the form of, preferably configurable, data types to at least one receiver, and wherein a periodic dispatch of data, in particular individually definable in its periodicity, is carried out by the radio node. The periodic dispatch of data is carried out by the radio node taking into account a prioritization. The periodic dispatch of the data is interrupted for a higher-priority dispatch of data or for a higher-priority bidirectional communication, whereby periodically provided dispatches are not carried out or are deferred in time.

### CROSS-REFERENCE TO RELATED APPLICATION

This application claims the priority, under 35 U.S.C. § 119, of German Patent Application DE 10 2024 106 303.3, filed Mar. 5, 2024; the prior application is herewith incorporated by reference in its entirety.

### FIELD AND BACKGROUND OF THE INVENTION

The present invention relates to a method for operating a radio node according to the independent method claim. The present invention further relates to a radio node according to the independent radio node claim.

A network infrastructure typically contains a plurality of radio nodes and at least one gateway and at least one head-end. The radio nodes are operated primarily with an autonomous energy source in the form of a long-life battery and communicate here via radio with the gateway, which forwards the received data to the head-end, and vice versa. In the case of a bidirectional data transmission, dispatches in the form of an uplink transmission are sent from the radio node via the gateway to the head-end, and are sent in the form of a downlink transmission from the head-end via the gateway to the radio node.

The radio nodes can support different network protocols here, e.g. Long Range Wide Area Network (LoRaWAN), MIOTY, Open Metering System (OMS) and/or wireless M-BUS. Additionally or alternatively, radio nodes can be operated in different communication operating modes, e.g. “stationary mode” (mode S), “frequent transmit mode” (mode T), “frequent receive mode” (mode R), “compact mode” (mode C), “narrowband VHF” (mode N) and/or the wireless “frequent receive and transmit mode” (mode F) of the wireless M-BUS, or “Class A”, “Class B” and/or “Class C” of LoRaWAN.

Radio nodes typically emit dispatches of data at periodic time intervals. Particularly if the radio nodes support a plurality of communication operating modes and/or network protocols, the case may arise in which one dispatch of data is intended to be carried out while another dispatch of data is already being carried out. In this case, the risk exists that the dispatch currently being carried out is interrupted so that the other dispatch can be started. The interrupted dispatch is not carried out to the end here, as a result of which it has to be repeated. The same applies to one bidirectional communication also, which is interrupted by the start of another dispatch. This causes high energy consumption and is therefore detrimental to the energy budget of the energy supply of the radio node.

Methods for coordinating dispatches and/or bidirectional communication are already known from the prior art. These methods are described e.g. by the corresponding standards, e.g. the LoRaWAN L2 1.0.4 specification (TS001-1.0.4), ETSI TS 103 357 V1.1.1 (2018-06), EN 13757-4 or the Open Metering System Specification Vol. 2-Primary Communication Issue 5.0.1/2023-12.

### SUMMARY OF THE INVENTION

The object of the present invention is to provide an improved method for operating a radio node, the method guaranteeing a reduction in energy consumption with consistent quality of service.

The aforementioned object is achieved by a method for operating a radio node according to the independent method claim, and by a radio node according to the independent radio node claim. Appropriate embodiments are claimed in the dependent claims.

According to the invention, a method is provided for operating a bidirectional radio node, in particular a sensor node, preferably a consumption meter, in a, preferably bidirectional, network infrastructure. The radio node supports at least one radio technology and is preferably operated with an autonomous energy source, in particular in the form of a long-life battery. The radio node dispatches data in the form of, preferably configurable, data types to at least one receiver, e.g. a gateway or a head-end, and wherein a periodic dispatch of data, said dispatch being, in particular, individually definable in its periodicity, is carried out by the radio node. According to the invention, the periodic dispatch of data is carried out by the radio node taking into account a prioritization, wherein the periodic dispatch of the data is interrupted for a higher-priority dispatch of data or for a higher-priority bidirectional communication, whereby periodically provided dispatches are not carried out or are deferred in time. The dispatches can thereby be carried out according to their prioritization. It can thus be guaranteed that a periodic dispatch is not interrupted as soon as a higher-priority periodic dispatch or a higher-priority bidirectional communication is carried out or started. A resumption of the interrupted periodic dispatch is consequently avoided. This results in a reduction in the energy consumption of the radio node. The quality of service of the radio node is, however, maintained.

In the periodic dispatch of data, the data are dispatched at consecutive time intervals. These time intervals define the periodicity. However, a pseudo-random time variance of the transmission can occur at the transmit times, such that the time of a dispatch of data can vary slightly here on expiry of the time interval. Collisions in the dispatch of data can thereby be avoided.

Prioritized and less-prioritized dispatches are appropriately provided during the periodic dispatch of data by the radio node, wherein an, in particular temporal, a priority in the dispatch sequence is granted to a prioritized dispatch compared with a less-prioritized dispatch, and the time sequence of the prioritized dispatch and the less-prioritized dispatch is implemented such that the less-prioritized dispatch does not collide with the prioritized dispatch. As a result, a less-prioritized dispatch can, for example, be put back, i.e. deferred in time or not transmitted, so that it is carried out only at a time when no prioritized dispatch would be carried out. In particular, the interruption of a less-prioritized dispatch in order to allow a prioritized dispatch to be carried out can thereby be prevented.

An, in particular temporal, priority can advantageously be granted to a bidirectional communication between the radio node and the receiver compared with periodic dispatches of the data, in particular a prioritized dispatch or a less-prioritized dispatch. A bidirectional communication can consequently be treated as prioritized, whereby a priority is granted to the bidirectional communication. It can thereby be ensured that a bidirectional communication that is taking place is not interrupted and does not have to be repeated. Since a bidirectional communication has a high energy requirement, the energy consumption of the radio node can be particularly effectively reduced as a result.

A time range can preferably be defined or reserved as a prioritized time interval for a prioritization, preferably for a bidirectional communication or a prioritized dispatch. In particular, periodic dispatches, in particular less-prioritized periodic dispatches, cannot be executed in the time range or deferred in time such that they do not fall within the time range. Time ranges within which only prioritized dispatches or a bidirectional communication are intended to be carried out can thereby be reserved in the radio node. The radio node can consequently control the temporal sequence of the periodic dispatches and/or the bidirectional communication.

Since the time range can be defined or reserved for a periodic dispatch and a subsequently received reply in the form of a downlink transmission from the receiver in order to set up a bidirectional communication, other periodic dispatches of the radio node in the time range can be prevented. An interruption of the bidirectional communication by a periodic dispatch can thereby be prevented.

The time range of the bidirectional communication is advantageously defined or reserved only when the reply is received from the receiver.

A fixed timeframe, in particular a fixed maximum timeframe, of the time range can preferably be predefined. Advantageously, this timeframe cannot be extended, so that a periodic dispatch provided for the time range and lasting longer than is predefined by the timeframe is interrupted. The radio node is thereby protected against an excessively high energy consumption.

Since the reservation of the time range can be cancelled if the bidirectional communication or the periodic dispatch is ended, the reserved time range that is no longer required can be released for periodic dispatches of the radio node.

The bidirectional communication of the radio node with the at least one receiver, e.g. the gateway and/or the head-end, can advantageously consist of a sequence of commands, the length of which is unknown, in particular to the radio node.

The prioritization can preferably be determined on the basis of:
an energy consumption at the expense of the autonomous energy source, and/or
a required transmit frequency or quality of service, and/or
a required transmit interval length or interval quality, and/or
an actual transmit frequency, and/or
an actual dispatch duration, and/or
a channel occupancy or a duty cycle.

The energy consumption of the periodic dispatch and/or the bidirectional communication at the expense of the autonomous energy source can appropriately be determined or estimated by the radio node. Alternatively, the energy consumption of the periodic dispatch and/or the bidirectional communication can be predefined and e.g. stored in the radio node. A periodic dispatch and/or a bidirectional communication with a high energy consumption preferably has a higher priority, and vice versa.

The required transmit frequency or quality of service preferably relates to a predefinition of how often the radio node is intended to carry out periodic dispatches within a predefined time period, e.g. within one day. A higher priority can be assigned to the periodic dispatch and/or the bidirectional communication if the required transmit frequency has not yet been achieved.

The required transmit interval length or interval quality appropriately relates to a predefined interval or a predefined interval range which is intended to be adhered to for the periodic dispatch. The priority of the periodic dispatch and/or the bidirectional communication is preferably higher according to the strictness of the predefinitions for adherence to the interval or the interval range.

The actual transmit frequency of the periodic dispatch relates, in particular, to the actual number of periodic dispatches within an, e.g. predefined, time range. A periodic dispatch having a higher actual transmit frequency can have a lower priority here. Conversely, a periodic dispatch having a lower transmit frequency can have a higher priority.

The prioritization can appropriately be determined on the basis of the actual dispatch duration. The dispatch duration is, in particular, the time that is required to transmit the periodic dispatch.

Additionally or alternatively, the priority can preferably be determined on the basis of the channel occupancy or the duty cycle of the radio channel provided for the periodic dispatch. The channel occupancy is the ratio, expressed as a percentage, of the transmission time of the radio node to an observation time period, e.g. one hour.

Since the priority of the respective periodic dispatches can be determined dynamically, the priority of the periodic dispatches can be adjusted to changing circumstances.

The prioritization is appropriately defined as set out in the following table:

TABLE

| Priority | Data transmission type |
|---|---|
| Highest priority | Transmission as start of a bidirectional |
| | communication |
| Second-highest priority | Transmission of transmit-time-relevant data |
| Third-highest priority | Transmission to a fixed network |
| Fourth-highest priority | Transmission to a mobile network |

The transmission of transmit-time-relevant data relates, in particular, to dispatches which have a particular temporal quality. This means, in particular, that the dispatches are intended to be transmitted at a predefined time at which, compared to other dispatches, a small temporal tolerance is intended to be adhered to.

The prioritization is advantageously not defined on the basis of an alarm and/or on the basis of non-periodic data.

The radio node preferably supports a first radio technology and a second radio technology. The radio technologies are preferably network protocols and/or communication operating modes. The radio node can thereby communicate with one or more receivers using a plurality of radio technologies. One radio technology can be given a higher prioritization than the other.

The range of the first radio technology can advantageously be greater than that of the second radio technology. The first radio technology is preferably a long-range radio technology and the second radio technology a short-range radio technology. As a result, e.g. in the event of maintenance, a bidirectional communication with the radio node can be set up by a service technician using the second radio technology with the shorter range, which is prioritized over the first radio technology.

The first radio technology is preferably a fixed network in which the receiver is installed as stationary, and the second radio technology is preferably a mobile network in which the receiver is mobile. A communication with the radio node, e.g. a read-out of the radio node designed as a consumption meter, by means of a drive-by or walk-by readout or a required service deployment, can thereby be enabled.

The radio technology, preferably the first radio technology and/or the second radio technology, is advantageously a narrowband radio technology. In particular, the signal bandwidth of the radio node here is less than 250 kHz, preferably less than 130 kHz, particularly preferably less than 20 KHz.

The radio technology, preferably the first radio technology and/or the second radio technology, can appropriately be an ISM (Industrial, Scientific and Medical) radio technology. Alternatively, the radio technology, preferably the first radio technology and/or the second radio technology, can be an SRD (Short Range Device) radio technology. Dispatches of the first and/or second radio technology can consequently be carried out via a radio channel in the range from 169.400-169.475 MHz, 169.4000-169.8125 MHz, 433.05-434.79 MHz, 865.0-868.0 MHz or 868.0-868.6 MHz or 869.4-869.65 MHz or 902-928 MHz.

Telegram splitting can preferably be used in the radio technology, preferably in the first and/or the second radio technology, whereby the data or data telegrams are not dispatched in one piece, but instead are split up into individual data packets or data sub-packets, and are reassembled or recombined by the receiver, e.g. the gateway and/or the head-end. In the bidirectional communication, the telegram splitting can similarly be used in both the uplink and the downlink.

The radio technology, in particular the first radio technology and/or the second radio technology, is advantageously a chirp-based radio technology. The transmit frequency of the periodic dispatch of data, in particular the data telegram with which the data are transmitted, changes here over time.

A burst mode is appropriately used in the radio technology, in particular in the first radio technology and/or the second radio technology. A dispatch of data, in particular a data telegram, can preferably be carried out once or multiple times with the same data content by means of the burst mode. A redundancy value which defines the number of repetitions of the data telegram in burst mode can be determined for this purpose.

The individual data packets or data sub-packets can be dispatched via a single frequency channel or alternatively via a plurality of different frequency channels using frequency hopping.

A configurable telegram content is preferably provided for the periodic dispatch of data by the radio node. Any data can consequently be transmitted.

Since the radio node opens at least one receive window after carrying out the periodic dispatch, the radio node can be ready to receive at specific times only, as a result of which the energy consumption of the radio node can be further reduced.

Furthermore, a bidirectional radio node, in particular a sensor node, preferably a consumption meter, is used secondarily, wherein the radio node contains an antenna, a transceiver device, a control unit and preferably an autonomous energy source, in particular in the form of a long-life battery. According to the invention, the radio node is operated using the method claims.

The method for controlling the radio node is preferably implemented in the firmware of the radio node, in particular in the firmware of the control unit of the radio node. As a result, the radio node can carry out the method autonomously.

The network protocol is appropriately the Long Range Wide Area Network (LoRaWAN) network protocol, as described, for example, in the LoRaWAN L2 1.0.4 specification (TS001-1.0.4), and/or the MIOTY network protocol as described e.g. in ETSI TS 103 357 V1.1.1 (2018-06), and/or the Open Metering System (OMS) network protocol, as described, for example, in the Open Metering System Specification—General Part Issue 2.4.1/2023-12 and/or the Open Metering System Specification Vol. 2—Primary Communication Issue 5.0.1/2023-12, and/or the wireless M-BUS network protocol, as described, for example, in EN 13757-4.

The communication operating mode of the radio technology, preferably the first radio technology and/or the second radio technology, is advantageously a “stationary mode” (mode S) and/or “frequent transmit mode” (mode T) and/or “frequent receive mode” (mode R) and/or “compact mode” (mode C) and/or “narrowband VHF” (mode N) and/or “frequent receive and transmit mode” (mode F) according to the wireless M-BUS network protocol, as described, for example, in EN 13757-4. Alternatively or additionally, the communication operating modes are “Class A” and/or “Class B” and/or “Class C” according to the Long Range Wide Area Network (LoRaWAN) network protocol, as described, for example, in the specification LoRaWAN L2 1.0.4 (TS001-1.0.4).

Other features which are considered as characteristic for the invention are set forth in the appended claims.

Although the invention is illustrated and described herein as embodied in a method for operating a radio node, and a radio node, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a highly simplified schematic view of an example of a network infrastructure having a plurality of bidirectional radio nodes;

FIG. 2 is a block diagram of the bidirectional radio node according to FIG. 1;

FIG. 3 is an illustration which shows, by way of example, a view of periodic dispatches of the radio node as shown in FIG. 1 over time;

FIGS. 4A-4B are illustrations which show, by way of example, a view of periodic dispatches of the radio node as shown in FIG. 1 according to a first exemplary embodiment of the method in which a less-prioritized dispatch is deferred;

FIGS. 5A-5B are illustrations which show, by way of example, a view of periodic dispatches of the radio node as shown in FIG. 1 according to a second exemplary embodiment of the method in which a less-prioritized dispatch is not transmitted; and

FIG. 6 is an illustration which shows, by way of example, a view of periodic dispatches of the radio node as shown in FIG. 1 according to a third exemplary embodiment of the method in which a bidirectional communication has a higher prioritization.

### DETAILED DESCRIPTION OF THE INVENTION

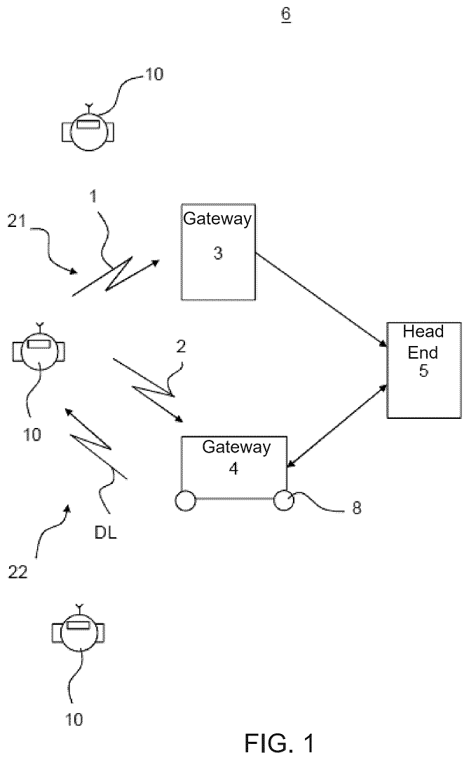

Referring now to the figures of the drawings in detail and first, particularly to FIG. 1 thereof, there is shown a network infrastructure 6 having a plurality of bidirectional radio nodes 10 and a head-end 5. The network infrastructure 6 further contains a first gateway 3 and a second gateway 4.

The radio node 10 transmits e.g. data by means of a first periodic dispatch 1 in the form of an uplink transmission using a first radio technology 21 to the first gateway 3. The first gateway 3 forwards the first periodic dispatch 1 to the head-end 5. The head-end 5 can emit a downlink transmission (not shown in the figures) using the first radio technology 21 in response to the first periodic dispatch 1.

The radio node 10 further transmits e.g. data by means of a second periodic dispatch 2 in the form of an uplink transmission using a second radio technology 22 to the gateway 4 which forwards the second periodic dispatch 2 to the head-end 5. In response to the second periodic dispatch 2, the head-end 5 can emit a downlink transmission DL which is forwarded via the second gateway 4 by means of the second radio technology 22 to the radio node 10.

Following the second periodic dispatch 2, the radio node 10 preferably opens at least one receive window in order to receive the downlink transmission DL from the second gateway 4. A bidirectional communication 20 is thereby enabled between the radio node 10 and the second gateway 4 or the head-end 5, wherein the bidirectional communication 20 consists of a sequence of commands, the length of which is unknown to the radio node 10. The firmware of the radio node 10, for example, can be updated, or a time synchronization can be carried out by means of the bidirectional communication 20. The bidirectional communication 20 comprises the second periodic dispatch 2 and the downlink transmission DL initiated by the second periodic dispatch 2.

Data in the form of configurable data types having a configurable telegram content are transmitted by means of the first or second periodic dispatch 1, 2 from the radio node 10 to the first or second gateway 3, 4 and are forwarded by the first or second gateway 3, 4 to the head-end 5.

The gateway 4 communicating by means of the second radio technology 22 can be mobile, as indicated in FIG. 1 by wheels 8. The second radio technology 22 can therefore be a mobile network. The first radio technology 21 can be a fixed network having a gateway 3. In particular, the first radio technology 21 is suitable for a long-range communication, and the second radio technology 22 is suitable for a short-range communication. The radio technologies 21, 22 are, in particular, different network protocols.

The first and/or second radio technology 21, 22 is/are preferably operated using the telegram-splitting method, in which data packets are divided into data sub-packets, are dispatched using different frequencies and are recombined into data packets by the receiver.

Alternatively, the first periodic dispatch 1 and the second periodic dispatch 2 can be carried out using the same radio technology 21 or 22. The periodic dispatches 1, 2 can therefore be transmitted via the same gateway 3 or 4. The first periodic dispatch 1 and the second periodic dispatch 2 can, in particular, be different communication operating modes of one radio technology 21 or 22.

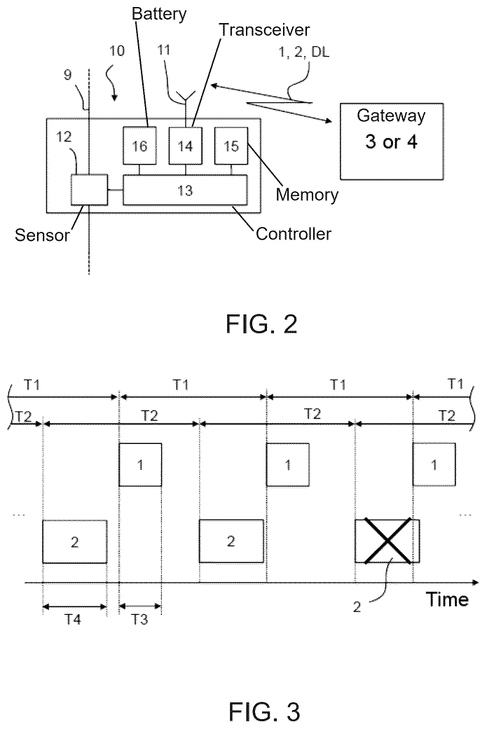

The radio node 10 is supplied with energy via an autonomous energy source in the form of a non-rechargeable long-life battery 16, cf. FIG. 2. A service life “in the field” of at least 10 years can normally be achieved with a long-life battery 16 of this type.

The radio node 10 further comprises a control unit 13 and a memory 15. The radio node 10 in FIG. 2 is a sensor device for capturing data of any type. To do this, the radio node 10 contains a sensor 12 fitted to a supply line 9, for example to measure power consumption or the flow of a liquid or gas.

The measured values captured by the sensor 12 are transmitted to the control unit 13 and are stored, for example, in a memory 15. The control unit 13 can access the measured values stored in the memory 15 and can transmit them via a transceiver device 14 and an antenna 11 as the first or second periodic dispatch 1, 2, e.g. as a data telegram, to the first gateway 3 using the first radio technology 21, or to the second gateway 4 using the second radio technology 22. The radio node 10 can receive the downlink transmissions DL by means of the antenna 11 and the transceiver device 14.

As shown in FIG. 3, the radio node 10 transmits data, e.g. data telegrams, as the first and second periodic dispatch 1, 2 at periodic time intervals T1, T2. The periodicity of the time intervals T1, T2 is individually definable.

The radio node 10 carries out the first periodic dispatch 1 to the first gateway 3 in the time interval T1, cf. FIG. 3. The second periodic dispatch 2 is further carried out from the radio node 10 to the second gateway 4 in the time interval T2. A first or second periodic dispatch 1 or 2 is thus carried out on expiry of the respective time interval T1, T2.

The radio node 10 requires a specific time T3 to carry out the first periodic dispatch 1, and a specific time T4 to carry out the second periodic dispatch 2. Consequently, as shown in FIG. 3, the case may occur in which the transmission of a second periodic dispatch 2 has not yet ended when the first periodic dispatch 1 is intended to be carried out on expiry of the time interval T1. In this case, the transmission of the second periodic dispatch 2 is interrupted, cf. the struck-through second periodic dispatch 2 in FIG. 3, and the first periodic dispatch 1 is started. Since the second periodic dispatch 2 has not been successfully completed, it must be repeated so that the data are completely present in the second gateway 4. This retransmission of the second periodic dispatch 2 results in high energy consumption of the radio node 10.

In order to avoid an interruption of the second dispatch 2 and prevent a repeat performance of the same dispatch, the periodic dispatch 1, 2 of data by the radio node 10 is carried out taking account of a prioritization, wherein the periodic dispatch 1, 2 of the data is interrupted for a higher-priority dispatch 1 or 2 of the data or for a higher-priority bidirectional communication 20, whereby periodically provided dispatches 1 or 2 are not carried out or are deferred in time. As a result, priority can be granted in the temporal sequence of the dispatches to a prioritized dispatch as opposed to a less-prioritized dispatch so that the prioritized dispatch does not collide with the less-prioritized dispatch.

The prioritization is defined here on the basis of an energy consumption at the expense of the autonomous energy source 16, and/or a required transmit frequency (quality of service), and/or transmit interval length (interval quality), and/or an actual transmit frequency, and/or an actual dispatch duration, and/or a channel occupancy (duty cycle).

The energy consumption of the first and/or second periodic dispatch 1, 2 depends, in particular, on the content and/or the data and/or on the requirements of the first and/or second periodic dispatch 1, 2. A long-range transmission using the first radio technology 21, for example, thus requires significantly more energy than a short-range transmission using the second radio technology 22. In this respect, a long-range transmission has a higher priority than a short-range transmission due to the higher energy requirement.

The required transmit frequency or quality of service relates to a time specification which determines how often the radio node 10 is intended to carry out the first or second periodic dispatch 1, 2 within a predefined time period, e.g. within one day. The periodic dispatch 1, 2 for which the required transmit frequency is not yet achieved has a higher priority here.

Conversely, the required transmit interval length or interval quality relates to a predefined interval or to a predefined interval range which is intended to be adhered to for the first or second periodic dispatch 1, 2. The priority of a periodic dispatch 1, 2 is consequently higher according to the strictness of the specifications for adherence to the interval or interval range.

The actual transmit frequency relates to the frequency with which the first or second periodic dispatch 1, 2 is carried out within a predefined time range. With a high actual transmit frequency, the first or second periodic dispatch 1, 2 can be made up for in real time with a subsequent first or second periodic dispatch 1, 2. Conversely, if the transmit frequency is very low, the corresponding first or second dispatch 1, 2 has a higher priority since it can be made up for only at a significantly later time.

The actual dispatch duration relates to the time that is required in order to carry out the first or the second periodic dispatch 1, 2 of data. The actual dispatch duration depends e.g. on the data rate at which the first or the second periodic dispatch 1, 2 is transmitted.

The prioritization is further influenced by the channel occupancy or duty cycle of the radio channel via which the first or second periodic dispatch 1, 2 is carried out. The priority of the first or second dispatch 1, 2 preferably increases with increasing channel occupancy of the radio channel.

The prioritization is determined dynamically here. As a result, the prioritization of the first or second dispatch 1, 2 can be adapted to current circumstances.

In particular, the prioritization is defined as set out in the following table:

| Priority | Data transmission type |
|---|---|
| Highest priority | Transmission as start of a bidirectional |
| | communication 20 |
| Second-highest priority | Transmission of transmit-time-relevant data |
| Third-highest priority | Transmission to a fixed network |
| Fourth-highest priority | Transmission to a mobile network |

The highest priority is therefore always assigned to a bidirectional communication 20.

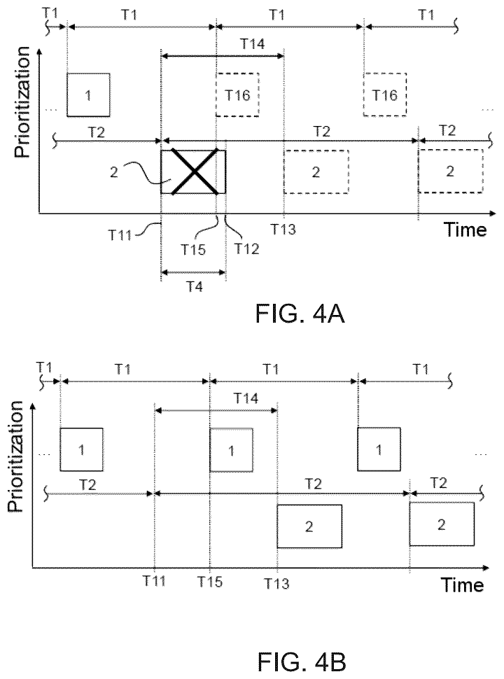

FIGS. 4A and 4B show an example of the sequence of the method according to a first exemplary embodiment. The first periodic dispatch 1 has a prioritization here, as a result of which the second periodic dispatch 2 is less prioritized.

The first periodic dispatch 1 is carried out in the predefined time interval T1. The second periodic dispatch 2 is carried out in the predefined time interval T2. Time ranges T16 having a fixed, predefined maximum timeframe and within which the first periodic dispatch 1 is intended to be carried out on expiry of the respective time intervals T1 are reserved in the radio node 10, cf. FIG. 4A.

As shown in FIG. 4A, a second periodic dispatch 2 is intended to be carried out by the radio node 10, starting at time T11 and ending at time T12.

The reserved time range T16 of the first periodic dispatch 1 starts at time T15, i.e. before time T12 at which the second periodic dispatch 2 is intended to end. The transmission of the first periodic dispatch 1 is consequently intended to be started when the second periodic dispatch 2 has not yet ended.

This is recognized by the radio node 10, which gives priority to the prioritized first periodic dispatch 1 over the less-prioritized second periodic dispatch 2. The second periodic dispatch 2 is not transmitted by the radio node 10 at the intended time T11, cf. the struck-through second periodic dispatch 2 in FIG. 4A. Instead, the time at which the second periodic dispatch 2 is carried out is deferred by the time T14, so that the second periodic dispatch 2 is carried out at time T13. This ensures that the second periodic dispatch 2 does not fall within the time range T16.

Provided that the first periodic dispatch 1 has ended before the predefined maximum timeframe of the time range T16 is reached, the reservation of the time range T16 is released so that the time range T16 that is no longer required can be used for periodic dispatches 1, 2.

As shown in FIG. 4B, the first periodic dispatch 1 can therefore take place at the planned time T15 without the second periodic dispatch 2 being interrupted as a result, since the second periodic dispatch 2 is deferred by the time T14 and then no longer collides with the first periodic dispatch 1. The predefined time interval T2 for carrying out the second periodic dispatch 2 is not influenced by the deferral of the second periodic dispatch 2.

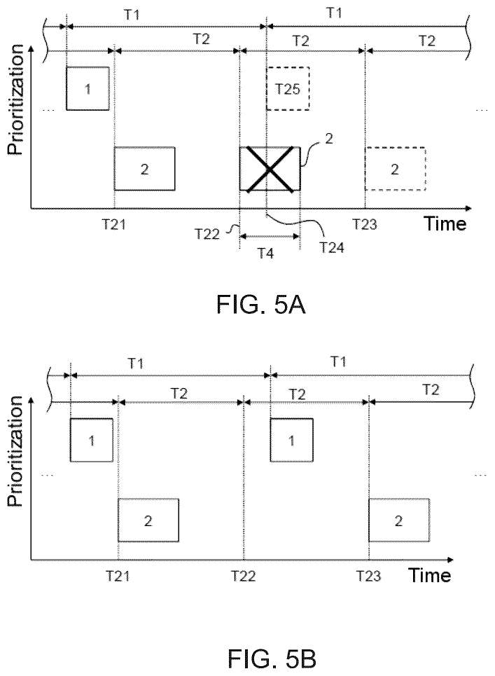

According to a second exemplary embodiment of the method, cf. FIGS. 5A and 5B, the second periodic dispatch 2 is carried out at a time T21. On expiry of the time interval T2, a subsequent second periodic dispatch 2 is intended to be carried out at time T22.

A first periodic dispatch 1 for which a time range T25 with a fixed, predefined maximum timeframe is reserved is intended to take place at time T24. The reserved time range T25 starts at time T24 and therefore before the end of the transmission of the second periodic dispatch 2. As in the first exemplary embodiment, the first periodic dispatch 1 has a prioritization over the second periodic dispatch 2. Priority is thereby given to the first periodic dispatch 1.

According to the second exemplary embodiment, the second periodic dispatch 2 is not carried out, cf. the struck-through second periodic dispatch 2 in FIG. 5A. In the second exemplary embodiment, the second periodic dispatch 2 that it is not carried out is not deferred, in contrast to the first exemplary embodiment. Instead, the second periodic dispatch 2 is released at time T22, cf. FIG. 5B. The data and/or the content of the released second periodic dispatch 2 are transmitted by means of the subsequent second periodic dispatch 2 at time T23. Since the second periodic dispatch 2 is not carried out, the interruption thereof due to the prioritized first periodic dispatch 1 is prevented.

Provided that the first periodic dispatch 1 has ended before the predefined maximum timeframe of the time range T25 is reached, the reservation of the time range T25 is released so that periodic dispatches 1, 2 can take place within the time range T25 that is no longer required.

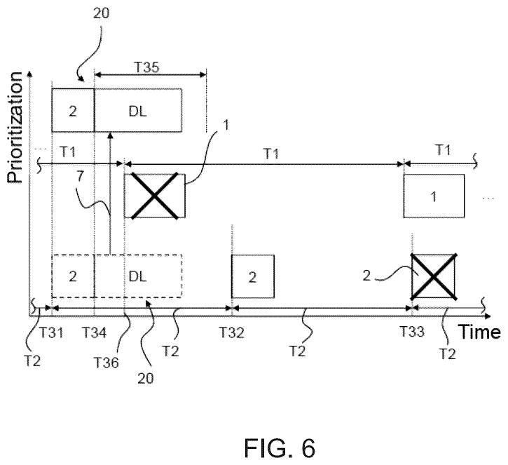

According to a third exemplary embodiment, cf. FIG. 6, the first periodic dispatch 1 is prioritized over the second periodic dispatch 2. In FIG. 6, a second periodic dispatch 2 is carried out at time T31. The second gateway 4 then transmits, cf. FIG. 1, a downlink transmission DL to the radio node 10 in response to the second periodic dispatch 2. The radio node 10 receives the downlink transmission DL at time T34, as a result of which the bidirectional communication 20 starts. A bidirectional communication of this type can take place e.g. in the event of a service deployment by a service technician present on-site.

The highest priority and therefore a higher prioritization 7 compared with the prioritized first periodic dispatch 1 and the less-prioritized second periodic dispatch 2 is granted here to the bidirectional communication 20. Priority over the first and second periodic dispatch 1, 2 is consequently granted to the bidirectional communication 20.

On reception of the downlink transmission DL, a time range T35 having a fixed, predefined maximum timeframe and directly following time T34 at which the downlink transmission is received is further reserved in the radio node 10. The first periodic dispatch 1 which is intended to be carried out at time T36 lies within the reserved time range T35, so that the first periodic dispatch 1 is not carried out due to the higher prioritization 7 of the bidirectional communication 20, cf. the struck-through first periodic dispatch 1 in FIG. 6. Interruption of the bidirectional communication 20 by the periodic dispatch 1 is thereby prevented. The content and/or the data of the first periodic dispatch 1 are transmitted only with the subsequent first periodic dispatch 1 on expiry of the time interval T1, cf. the second exemplary embodiment of the method according to FIGS. 5A, 5B. Alternatively, the first periodic dispatch 1 can also be deferred according to the first exemplary embodiment of the method, cf. FIGS. 4A and 4Bb.

The bidirectional communication 20 is therefore not interrupted, so that it does need to be repeated. This ensures that a bidirectional communication 20 that has started is carried out completely. Since a bidirectional communication 20 is particularly energy-intensive, the energy consumption of the radio node 10 can be particularly effectively reduced as a result.

Provided that the bidirectional communication 20 has ended before the expiry of the predefined maximum timeframe of the time range T35, the reservation of the time range T35 in the radio node 10 can be cancelled. Periodic dispatches 1, 2 can consequently be carried out by the radio node 10. Provided that the bidirectional communication 20 lasts longer than the predefined maximum timeframe of the time range T35, the bidirectional communication 20 is interrupted once the maximum timeframe is reached. An excessive energy consumption by the long-lasting bidirectional communication 20 is thereby avoided.

On completion of the bidirectional communication 20, a further second periodic dispatch 2 is carried out on expiry of the time interval T2 at time T32, cf. FIG. 6. The second periodic dispatch 2 has the same prioritization here as before the bidirectional communication 20 and is therefore less prioritized compared with the first periodic dispatch 1. On expiry of a further time interval T2, a further performance of the second periodic dispatch 2 at time T33 is planned. However, this coincides temporally with the prioritized first periodic dispatch 1. The second periodic dispatch 2 is accordingly not carried out at time T33, cf. the struck-through second periodic dispatch 2 in FIG. 6, but instead is deferred, cf. the first exemplary embodiment according to FIGS. 4A and 4B, or suspended, cf. the second exemplary embodiment according to FIGS. 5a and 5b.

The method according to the invention is appropriately implemented in the firmware of the radio node 10, in particular in the control unit 13 of the radio node 10. As a result, the method can be carried out independently by the radio node 10.

According to the method, a less-prioritized second periodic dispatch 2 can be deferred or suspended if it collides temporally with a prioritized first periodic dispatch 1 or a bidirectional communication 20. As a result, interruption of a periodic dispatch 1, 2 that has started can be prevented, thus contributing to an effective energy saving.

The invention therefore makes a substantial contribution in the relevant technical domain.

The following is a summary list of reference numerals and the corresponding structure used in the above description of the invention:
1 Dispatch
2 Dispatch
3 Gateway
4 Gateway
5 Head-end
6 Network infrastructure
7 Higher prioritization
8 Wheel
9 Supply line
10 Radio node
11 Antenna
12 Sensor
13 Control unit
14 Transceiver device
15 Memory
16 Long-life battery
20 Bidirectional communication
21 Radio technology
22 Radio technology
DL Downlink transmission
T1 Time interval
T2 Time interval
T3 Time
T4 Time
T11-T13 Time
T14 Time
T15 Time
T16 Time range
T21-T24 Time
T25 Time range
T31-T34 Time
T35 Time range
T36 Time

1. A method for operating a bidirectional radio node in a network infrastructure, wherein the bidirectional radio node supports at least one radio technology, which comprises the steps of:
dispatching, via the bidirectional radio node, data in a form of configurable data types to at least one receiver; and
carrying out a periodic dispatch of the data by the bidirectional radio node, the periodic dispatch of the data is carried out by the bidirectional radio node taking into account a prioritization, wherein the periodic dispatch of the data is interrupted for a higher-priority dispatch of the data or for a higher-priority bidirectional communication, whereby periodically provided dispatches are not carried out or are deferred in time.

2. The method according to claim 1, wherein:
prioritized dispatches and less-prioritized dispatches are provided in the periodic dispatch of the data by the bidirectional radio node;
a priority in a dispatch sequence is granted to a prioritized dispatch over a less-prioritized dispatch; and
a temporal sequence of the prioritized dispatch and the less prioritized dispatch is implemented such that the less-prioritized dispatch does not collide with the prioritized dispatch.

3. The method according to claim 1, wherein a priority is granted to the higher-priority bidirectional communication between the bidirectional radio node and the at least one receiver compared with the periodic dispatches of the data.

4. The method according to claim 1, wherein a time range is defined or reserved as a prioritized time interval for a prioritization, and, within the time range, the periodic dispatches of the data are not carried out or are deferred in time such that they do not fall within the time range.

5. The method according to claim 4, wherein the time range is defined or reserved in response to the periodic dispatch and a reply received thereto from the at least one receiver in order to set up the higher-priority bidirectional communication.

6. The method according to claim 4, wherein that a fixed timeframe is predefined for the time range.

7. The method according to claim 1, wherein the higher-priority bidirectional communication of the bidirectional radio node with the at least one receiver includes a sequence of commands of unknown length.

8. The method according to claim 1, which further comprises defining the prioritization on a basis of:
an energy consumption at an expense of an autonomous energy source; and/or
a required transmit frequency; and/or
a transmit interval length; and/or
an actual transmit frequency; and/or
an actual dispatch duration; and/or
a channel occupancy.

9. The method according to claim 1, wherein the prioritization is defined as set out as follows:
a. Highest priority-Transmission as start of the bidirectional communication;
b. Second-highest priority-Transmission as start of the bidirectional communication;
c. Third-highest priority-Transmission to a fixed network; and
d. Fourth-highest priority-Transmission to a mobile network.

10. The method according to claim 1, wherein the bidirectional radio node supports the at least one technology which includes a first radio technology and a second radio technology.

11. The method according to claim 10, wherein a range of the first radio technology is greater than that of the second radio technology.

12. The method according to claim 10, wherein:
the at least one radio receiver includes a first receiver and a second receiver;
the first radio technology is a fixed network in which the first receiver is installed as stationary; and
the second radio technology is a mobile network in which the second receiver is mobile.

13. The method according to claim 1, wherein the at least one radio technology is a narrowband radio technology.

14. The method according to claim 1, wherein the at least one radio technology is an industrial, scientific and medical (ISM) technology or short range device (SRD) radio technology.

15. The method according to claim 1, wherein telegram splitting is used in the at least one radio technology.

16. The method according to claim 1, wherein the at least one radio technology is a chirp-based radio technology.

17. The method according to claim 1, which further comprising using a burst mode in the at least one radio technology.

18. The method according to claim 1, wherein a configurable telegram content is provided for the periodic dispatch of the data by the bidirectional radio node.

19. The method according to claim 1, wherein:
the bidirectional radio node is a sensor node or a consumption meter;
the bidirectional radio node is operated with an autonomous energy source; and
the periodic dispatch of the data is individually definable in its periodicity.

20. A radio node, comprising:
an antenna;
a transceiver device;
a controller;
an autonomous energy source; and
the radio node is operated according to the method of claim 1.
